(19) United States
(12) Patent Application Publication
(10) Pub. No.: US 2011/0014838 A1
(43) Pub. Date: Jan. 20, 2011

(54) LUMINANCE-ENHANCED FILM AND METHOD FOR FABRICATING THE SAME

(75) Inventors: Yeon Soo Kim, Gyeonggi-do (KR); Deog Jae Jo, Gyeonggi-do (KR); Jin Soo Kim, Seoul (KR); Do Hyun Kim, Gyeonggi-do (KR); In Young Yang, Daejeon (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Woongjin Chemical Co., Ltd.

(21) Appl. No.: 12/694,369

(22) Filed: Jan. 27, 2010

(30) Foreign Application Priority Data
Jan. 31, 2009 (KR) 10-2009-0007775
Jan. 31, 2009 (KR) 10-2009-0007776
Jan. 31, 2009 (KR) 10-2009-0007777

(51) Int. Cl. B32B 5/02; D03D 1/00; B32B 37/10

(52) U.S. Cl. 442/201; 428/292.1; 156/285

(57) ABSTRACT

Disclosed is a luminance-enhanced film. The luminance-enhanced film includes an intermediate layer comprising a birefringent island-in-the-sea yarn and a sheet laminated on both sides of the intermediate layer, wherein the interface between the intermediate layer and the sheet has an air-gap area ratio of 5% or less, and is characterized in that it is substantially free of curling and does not contain bubbles, thus exhibiting considerably superior optical efficiency and adhesion force. A liquid crystal display utilizing the luminance-enhanced film also advantageously exhibits considerably improved luminance.

### CROSS REFERENCE TO RELATED APPLICATIONS

This application claims the benefit under 35 U.S.C. §119(a) of Korean Patent Application Serial No. 10-2009-0007775, filed Jan. 31, 2009, Korean Patent Application Serial No. 10-2009-0007776, filed Jan. 31, 2009, and Korean Patent Application Serial No. 10-2009-0007777, filed Jan. 31, 2009, all of which are incorporated herein by reference in their entirety.

### BACKGROUND OF THE INVENTION

1. Technical Field

The present invention relates to a luminance-enhanced film and a method for fabricating the same, and more specifically, to a luminance-enhanced film and a method for fabricating the same to reduce curling and improve adhesion force and reliability.

2. Background Art

Liquid crystal displays (LCDs), projection displays and plasma display panels (PDPs) which have already secured their markets in the TV field are main for flat panel display technology. It is also expected that field emission displays (FEDs), electro-luminescent displays (ELDs), etc. will gain market share according to their respective characteristics along with the improvement of technologies associated therewith. The application range of LCDs currently expands to notebooks, personal computer monitors, liquid crystal TVs, vehicles, aircrafts, etc. LCDs occupy about 80% of the flat panel market and global sales are strong these days along with the sharply increased demand since the second half of 1998.

Conventional LCDs have a structure in which liquid crystal and an electrode matrix are disposed between a pair of light-absorbent optical films. In LCDs, the liquid crystal is moved by an electric field generated by applying an electric voltage to two electrodes and thus has an optical state depending on the electric field. This process displays an image by polarizing pixels storing information in a specific direction. For this reason, LCDs include a front optical film and a rear optical film to induce this polarization.

LCD devices do not necessarily have a high use efficiency of light emitted from a backlight. This is because 50% or more of the light emitted from the backlight is absorbed by a rear-side optical film. Accordingly, in order to increase the use efficiency of the backlight light in LCD devices, a luminance-enhanced film is interposed between an optical cavity and a liquid crystal assembly.

FIG. 1 is a view illustrating the optical principle of a conventional luminance-enhanced film.

More specifically, P-polarized light of light orienting from an optical cavity to a liquid crystal assembly is transferred through a luminance-enhanced film to the liquid crystal assembly and S-polarized light thereof is reflected from the luminance-enhanced film to the optical cavity, reflected from a diffusion reflection surface of the optical cavity in a state in which the polarization direction of the light becomes random, and then transferred to the luminance-enhanced film again. Consequently, the S-polarized light is converted into P-polarized light that can pass through a polarizer of the liquid crystal assembly and then transferred through the luminance-enhanced film to the liquid crystal assembly.

Selective reflection of the S-polarized light with respect to the incident light on the luminance-enhanced film and transmission of the P-polarized light are carried out by the difference in refractive index between respective optical layers, determination of an optical thickness of each optical layer according to extension of stacked optical layers and variation in the refractive index of the optical layer, in the state in which a flat sheet optical layer having an anisotropic refractive index and a flat sheet optical layer having an isotropic refractive index are alternately stacked in plural number.

That is, the light incident on the luminance-enhanced film undergoes the reflection of the S-polarized light and the transmission of the P-polarized light, while passing through the receptive optical layers. As a result, only the P-polarized light of the incident polarized light is transferred to the liquid crystal assembly. Meanwhile, the reflected S-polarized light is reflected from the diffusion reflection surface of the optical cavity in the state in which its polarization state becomes random as mentioned above and then transferred to the luminance-enhanced film again. Accordingly, loss of light generated from a light source and waste of power can be reduced.

However, this conventional luminance-enhanced film is fabricated by alternately stacking flat sheet-shaped isotropic optical layers and flat sheet-shaped anisotropic optical layers, which have different refractive indices, and performing an extension process on the stacked structure so that the stacked layer has an optical thickness and a refractive index of the respective optical layers, which can be optimized for selective reflection and transmission of incident polarized light. Accordingly, this fabrication process had a disadvantage of complicated fabrication of the luminance-enhanced film. In particular, since each optical layer of the luminance-enhanced film has a flat sheet shape, P-polarized light and S-polarized light have to be separated from each other in response to a wide range of an incident angle of the incident polarized light. Accordingly, this film has a structure in which an excessively increased number of optical layers are stacked, thus disadvantageously involving exponential increase in production costs. In addition, this structure disadvantageously causes optical loss and thus deterioration in optical performance.

Accordingly, in an attempt to solve the afore-mentioned problems of the stack-type luminance-enhanced film, a method wherein birefringent fibers are incorporated into a sheet was suggested. This method has an advantage of low production costs and easy production, since luminance-enhanced films are not fabricated in a stack-structure, when general birefringent fibers are used, but disadvantageously cannot improve luminance to a desired level and are thus unsuitable for application to industrial fields, instead of the stack-type conventional luminance-enhanced film.

Accordingly, the present inventors developed luminance-enhanced films and optical modulators with improved luminance by preparing fabric from birefringent island-in-the-sea yarns and then arranging an isotropic sheet as a supporter of the fabric on both sides of the fabric. However, this fabrication method has disadvantages of curled final films and residual bubbles present in stacked films and thus deterioration in optical efficiency.

Therefore, the present invention has been made in view of the above problems, and it is one object of the present invention to provide a luminance-enhanced film which is substantially free of a curling phenomenon and does not contain bubbles, thus exhibiting superior optical efficiency and adhesion performance.

It is another object of the present invention to provide a method for fabricating the luminance-enhanced film.

It is another object of the present invention to provide a liquid crystal display device comprising the luminance-enhanced film.

### SUMMARY OF THE INVENTION

In accordance with the present invention, the above and other objects can be accomplished by the provision of a luminance-enhanced film including: an intermediate layer comprising a birefringent island-in-the-sea yarn; and a sheet laminated on both sides of the intermediate layer, wherein the interface between the intermediate layer and the sheet has an air-gap area ratio of 3% or less.

The surface defect number may be preferably 3 per m² or less.

The stack strength between the intermediate layer and the sheet may be 500 g/15 mm width or higher.

The island portions and sea portions may have different optical properties, and preferably, the island portions are anisotropic and the sea portions are isotropic.

The island-in-the-sea yarns may have a single yarn fineness of 0.5 to 30 deniers, and the island portions of the island-in-the-sea yarns may have a single yarn fineness of 0.0001 to 1.0 deniers.

The island portions and the sea portions may be composed of a material selected from the group consisting of polyethylene naphthalate (PEN), copolyethylene naphthalate (co-PEN), polyethylene terephthalate (PET), polycarbonate (PC), polycarbonate (PC) alloys, polystyrene (PS), heat-resistant polystyrene (PS), polymethyl methacrylate (PMMA), polybutylene terephthalate (PBT), polypropylene (PP), polyethylene (PE), acrylonitrile butadiene styrene (ABS), polyurethane (PU), polyimide (PI), polyvinyl chloride (PVC), styrene acrylonitrile (SAN) mixtures, ethylene vinyl acetate (EVA), polyamide (PA), polyacetal (POM), phenol, epoxy (EP), urea (UF), melanin (MF), non-saturated polyester (UP), silicon (Si), elastomers, cycloolefin polymers and combinations thereof.

The sheet may be isotropic and may be the same material as the island portions or the sea portions.

The difference in refractive index between the sheet and the island-in-the-sea yarn with respect to two axial directions may be 0.05 or less and a difference in refractive index between the sheet and the island-in-the-sea yarn with respect to the remaining one axial direction may be 0.1 or more.

Assuming that x-, y- and z-axis refractive indexes of the sheet are nX1, nY1 and nZ1, respectively, and the x-, y- and z-axis refractive indexes of the island-in-the-sea yarn are nX2, nY2 and nZ2, respectively, at least one of x-, y- and z-axis refractive indexes of the sheet is equivalent to that of the birefringent island-in-the-sea yarn, and the refractive indexes of the birefringent island-in-the-sea yarn may be nX2>nY2=nZ2.

The difference in refractive index between the sea portion and the island portion with respect to two axial directions may be 0.05 or less and a difference in refractive index between the sea portion and the island portion with respect to the remaining one axial direction may be 0.1 or more.

Assuming that x- (longitudinal), y- and z-axis refractive indexes of the island portion are nX3, nY3 and nZ3, respectively, and the x-, y- and z-axis refractive indexes of the sea portion are nX4, nY4 and nZ4, respectively, at least one of x-, y- and z-axis refractive indexes of the island portion may be equivalent to that of the sea portion, and an absolute value of the difference in refractive index between nX3 and nX4 may be 0.05 or more.

The refractive index of the sea portion in the island-in-the-sea yarns may be equivalent to the refractive index of the sheet.

The sea portions and the island portions may be present in an area ratio of 2:8 to 8:2, based on the cross-section of the birefringent island-in-the-sea yarn, and the birefringent island-in-the-sea yarn may extend in a longitudinal direction.

The intermediate layer may comprise a fabric woven using birefringent island-in-the-sea yarn as at least one of weft and warp.

One of weft and warp of the fabric may be the birefringent island-in-the-sea yarn and the other is an isotropic fiber, wherein the birefringent island-in-the-sea yarn has a melting initiation temperature higher than a melting temperature of the isotropic fiber.

In accordance with another aspect, provided is a method for fabricating a luminance-enhanced film including: preparing an intermediate layer comprising a birefringent island-in-the-sea yarn; laminating a sheet on one or both sides of the intermediate layer to prepare a laminated sheet; and hot-pressing the laminated sheet using a vacuum hot press.

The hot-pressing may be carried out under a vacuum of 5 to 500 torr, at a pressure of 1.0 to 100 kgf/cm² and at a temperature of 120 to 180° C. for a process period of 1 to 30 minutes.

The hot-pressing may be carried out by interposing a plurality of the laminated sheets between heating plates, wherein a metal pad is stacked between the two respective laminated sheets.

In accordance with another aspect, provided is a liquid crystal display device including the luminance-enhanced film.

The liquid crystal display device may further include a reflection medium to re-reflect light modulated on the luminance-enhanced film.

Hereinafter, a brief description will be given of the terms used herein.

Unless specifically mentioned, the term “spinning core” means a specific point acting as a standard point at which island portions in island-in-the-sea yarns are grouped (partitioned), on the cross-section taken in a longitudinal direction.

The expression “island portions are arranged such that they are grouped” means a state in which the island portions of island-in-the-sea yarns are arranged, based on one or more spinning cores, such that they are partitioned in a predetermined shape, and for example, when two spinning cores are present in island-in-the-sea yarns, the island-in-the-sea yarns are arranged in a predetermined shape, based on respective spinning cores and the island portions are thus divided into two groups in the island-in-the-sea yarns.

The expression “fibers are birefringent” means that when light is irradiated to fibers having different refractive indices according to directions, the light incident to the fibers is refracted in two different directions.

The term “isotrope” means a property in which an object has a constant refractive index irrespective of a direction at which light passes through the object.

The term “anisotrope” means a property in which optical properties of an object are varied according to directions of light and an anisotropic object is birefringent and is contrary to isotrope.

The term “optical modulation” means a phenomenon in which irradiated light is reflected, refracted, or scattered, or intensity, wave cycle or characteristics thereof are varied.

The term “melting initiation temperature” means a temperature at which a polymer begins to melt, and the term “melting temperature” means a temperature at which melting occurs most rapidly. Accordingly, when a melting temperature of a polymer is observed by DSC, the temperature at which melting endothermic peak initially takes place is referred to as a “melting initiation temperature” and the temperature plotted at a maximum of the endothermic peak is referred to as a “melting temperature”.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating the principle of a conventional luminance-enhanced film;

FIG. 2 is an SEM image illustrating the cross-section of a conventional island-in-the-sea yarn;

FIG. 3 is a schematic view illustrating a luminance-enhanced film according to the present invention;

FIG. 4 is a perspective view illustrating a luminance-enhanced film according to the present invention;

FIG. 5 is a schematic view illustrating the cross-section of a specific island-in-the-sea yarn used in the present invention;

FIG. 6 is a schematic view illustrating the cross-section of a specific island-in-the-sea yarn used in the present invention;

FIG. 7 is a cross-sectional view illustrating an island-in-the-sea yarn (comprising 1040 island portions) used in the present invention;

FIG. 8 is a cross-sectional view illustrating a passage of light emitted to the birefringent island-in-the-sea yarns;

FIG. 9 is a schematic view illustrating a vacuum hot press used in the present invention;

FIG. 10 is a schematic view illustrating an LCD device comprising the luminance-enhanced film according to the present invention;

FIG. 11 is an SEM image of the cross-section of the luminance-enhanced film fabricated in Example 1;

FIG. 12 is an SEM image of the cross-section of the luminance-enhanced film fabricated in Comparative Example 1; and

FIG. 13 is an SEM image of the cross-section of the luminance-enhanced film fabricated in Comparative Example 2.

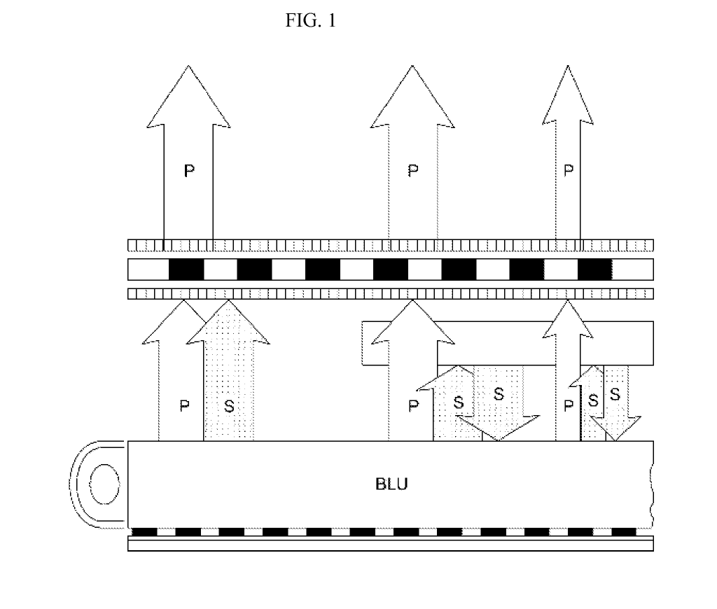

### DETAILED DESCRIPTION OF THE INVENTION

The present invention provides a luminance-enhanced film which is substantially free of a curling phenomenon and does not contain bubbles and thus exhibits considerably superior optical efficiency and adhesion performance. Accordingly, the liquid crystal display device using the luminance-enhanced film also advantageously exhibits superior luminance.

Hereinafter, the present invention will be illustrated in more detail.

The luminance-enhanced film comprises an intermediate layer comprising a birefringent island-in-the-sea yarn and a sheet laminated on both sides of the intermediate layer, wherein the interface between the intermediate layer and the sheet has an air-gap area ratio of 5% or less, and is characterized in that it is substantially free of curling, does not contain bubbles, and thus exhibits considerably superior optical efficiency and adhesion force.

The air-gap area ratio means a ratio of an air-gap area to a cross-sectional area of the luminance-enhanced film and the air-gap area means a total cross-sectional area of air gaps. Each cross-sectional area may be obtained by subjecting the cross-section of the luminance-enhanced film to SEM, copying air gaps in the SEM image onto a tracing paper, and cutting the paper and weighting the same. The air-gap area ratio refers to an average of air-gap areas measured from three cross-section SEM images with a size of 100 μm×100 μm of the luminance-enhanced film.

The luminance-enhanced film of the present invention has an air-gap area ratio of 3% or less, preferably, 1.5% or less. When the interface exists between the intermediate layer and the sheet, a great distance between the refractive index of the air gaps and the refractive index of the intermediate layer and the sheet occurs, inevitably causing non-uniformity in luminance, and the adhesion between the intermediate layer and the sheet is also deteriorated, lowering product reliability.

Meanwhile, the surface defect number of the luminance-enhanced film is defined as the number of defects (such as bubbles) measured by monitoring a luminance-enhanced film with a 32-inch TV screen size through a black board placed on the bottom thereof with the naked eye.

The surface defects are mostly caused by bubbles resulting in non-uniform luminance. The surface defect number is preferably 3 per m² or less, more preferably, 1 per m² or less.

Meanwhile, the luminance-enhanced film of the present invention preferably has stack strength between the intermediate layer and the sheet of 500 g/15 mm width or higher, wherein the stack strength is measured using a sample with 15 mm width at a tensile rate of 100 mm/min, when T-type detachment begins.

The use of birefringent island-in-the-sea yarn enables considerable improvement in optical modulation efficiency and luminance, as compared to the use of conventional birefringent fibers. Hereinafter, a detailed description of the birefringent island-in-the-sea yarn will be given.

The birefringent island-in-the-sea yarn of the present invention may be provided with a birefringent interface between island portions and sea portions, in order to maximize optical modulation efficiency such as improvement in luminance. For this purpose, the present invention may use the birefringent island-in-the-sea yarn wherein island portions are anisotropic and sea portions are isotropic, and vice versa. This case, where the interfaces between a plurality of island portions and a plurality of sea portions constituting the island-in-the-sea yarns as well as the interfaces between the island-in-the-sea yarns and the sheets are birefringent, exhibits considerably improved optical modulation efficiency, as compared to conventional birefringent fibers wherein only the interfaces between the sheet and the birefringent fibers are birefringent. Accordingly, as compared to the case where common birefringent fibers are used, the case where birefringent island-in-the-sea yarns are used exhibits more improved luminance.

Meanwhile, in order to maximize optical modulation efficiency, it is preferred that an area of birefringent interface present in the birefringent island-in-the-sea yarns be wider. For this purpose, the number of island portions present in the birefringent island-in-the-sea yarns should be as large as possible. Accordingly, rather than conventional island-in-the-sea yarns, the present invention uses specific island-in-the-sea yarns wherein the number of island portions is not less than 38 and not more than 1,500. Such an island-in-the-sea yarn has a structure in which island portions are grouped based on two or more spinning cores, to prevent excessive concentration of island portions and thus aggregation therebetween, and thereby ultimately considerably improving luminance.

Meanwhile, group-type island-in-the-sea yarns used in the present invention will be sufficient, when they have a fineness comparable to single yarn fineness of common island-in-the-sea yarns and preferably have a single yarn fineness of 0.5 to 30 deniers. Of the island-in-the-sea yarns, island portions preferably have a single yarn fineness of 0.0001 to 1.0 deniers, in view of efficient accomplishment of objects of the present invention. When the single yarn fineness is less than 0.0001 to 1.0 deniers, refraction, scattering and reflection effects may be reduced, and when the single yarn fineness exceeds 10 deniers, optical diffusion effects cannot be obtained to a desired level.

When the cross-sectional length (in the case of circular cross-section, diameter) of the island portion in the birefringent island-in-the-sea yarn is less than a light wavelength, refraction, scattering and reflection effects are decreased and optical modulation hardly occurs. When the cross-sectional diameter of each island portion is excessively large, light is regularly reflected from the surface of island-in-the-sea yarns and diffusion in other directions may be considerably slight. The cross-sectional diameter of island portions may be varied depending on an intended application of optical bodies. For example, the diameter of fibers may be varied depending on electromagnetic radiation wavelengths important for specific applications and different diameters of fibers are required to reflect, scatter or transmit visible, ultraviolet and infrared rays and microwaves.

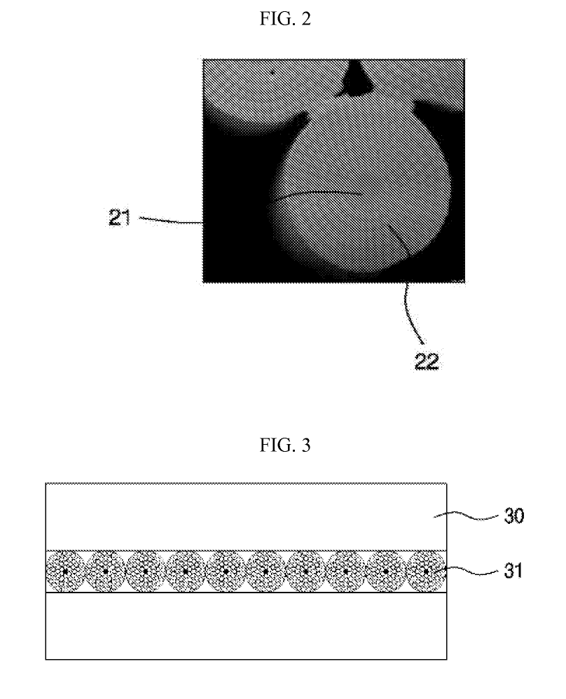

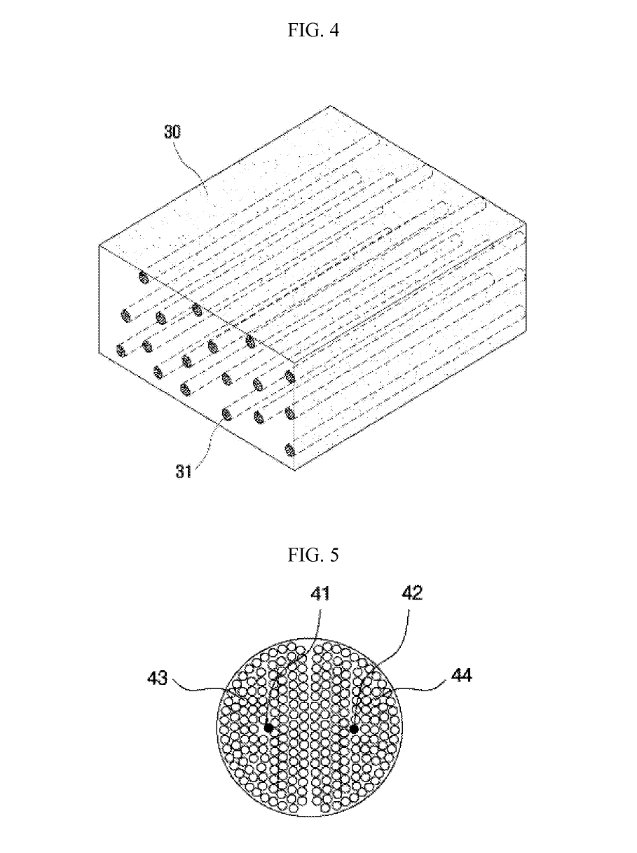

FIG. 2 is an SEM image illustrating the cross-section of a conventional island-in-the-sea yarn. In FIG. 2, island portions 22 are concentrically arranged based on one spinning core 21 in island-in-the-sea yarns. FIG. 3 is a schematic view illustrating the transverse cross-section of a luminance-enhanced film according to the present invention. Referring to FIG. 3, the luminance-enhanced film has a structure in which an intermediate layer comprising birefringent island-in-the-sea yarns is intervened in an isotropic sheet 30. The intermediate layer may take the form of birefringent island-in-the-sea yarns randomly arranged or a fabric woven using the birefringent island-in-the-sea yarns as at least one of wefts or warps. In addition, when the sheet 30 is pressed onto the birefringent island-in-the-sea yarns 31, which are randomly arranged in a horizontal direction, it is melt-adhered to the yarns 31 and the interface therebetween disappears. As a result, as shown in FIG. 4, the birefringent island-in-the-sea yarns 31 may be dispersed throughout the traverse cross-section thereof in the sheet 30.

The sea portions and/or island portions that can be used herein may be composed of the same material as the sheet, and examples thereof include poly(carbonate) (PC); syndiotactic and isotacticpoly(styrene) (PS); alkyl styrene; alkyl such as poly(methyl methacrylate) (PMMA) and PMMA copolymers, aromatic and aliphatic pendant (meth)acrylate; ethoxide and propoxide (meth)acrylate; multi-functional (meth)acrylate; acrylated epoxy; epoxy; and other ethylene unsaturated compounds; cyclic olefin and cyclic olefin copolymers; acrylonitrile butadiene styrene (ABS); styrene acrylonitrile (SAN) copolymers; epoxy; poly(vinyl cyclohexane); PMMA/poly(vinyl fluoride) blends; poly(phenylene oxide) alloys; styrene block copolymers; polyimide; polysulfone; poly(vinyl chloride); poly(dimethylsiloxane) (PDMS); polyurethane; unsaturated polyester; polyethylene; poly(propylene) (PP); poly(alkane terephthalate) such as poly(ethylene terephthalate) (PET); poly(alkane naphthalate) such as poly(etylene naphthalate) (PEN); polyamide; ionomers; vinyl acetate/polyethylene copolymers; cellulose acetate; cellulose acetate butyrate; fluoro polymers; poly(styrene)-poly(ethylene) copolymers; PET and PEN copolymers such as polyolefin PET and PEN; and poly(carbonate)/aliphatic PET blends. More preferably, examples of suitable sheets include polyethylene naphthalate (PEN), copolyethylene naphthalate (co-PEN), polyethylene terephthalate (PET), polycarbonate (PC), polycarbonate (PC) alloys, polystyrene (PS), heat-resistant polystyrene (PS), polymethyl methacrylate (PMMA), polybutylene terephthalate (PBT), polypropylene (PP), polyethylene (PE), acrylonitrile butadiene styrene (ABS), polyurethane (PU), polyimide (PI), polyvinyl chloride (PVC), styrene acrylonitrile (SAN) mixtures, ethylene vinyl acetate (EVA), polyamide (PA), polyacetal (POM), phenol, epoxy (EP), urea (UF), melanin (MF), non-saturated polyester (UP), silicon (Si), elastomers, cycloolefin polymers and combinations thereof. However, the birefringent island-in-the-sea yarns using polyethylene naphthalate (PEN) as an island ingredient, and an alloy of copolyethylene naphthalate (co-PEN) and polycarbonate (PC) or a combination thereof, as a sea ingredient, exhibit considerably improved luminance, as compared to birefringent island-in-the-sea yarns prepared from conventional materials. The term “alloy” used herein refers to a substance in which chemical reaction or other methods to stabilize phase separation are applied to the interface between phases, which is distinguished with a blend, which refers to a substance in which two or more polymers are physically mixed with one another. In particular, when the polycarbonate alloy is used as the sea ingredient, birefringent island-in-the-sea yarns with the most excellent optical modulation properties can be prepared. In this case, the polycarbonate alloy may be preferably composed of polycarbonate and modified glycol poly cyclohexylene dimethylene terephthalate (PCTG) and more preferably, use of the polycarbonate alloy consisting of the polycarbonate and modified glycol poly cyclohexylene dimethylene terephthalate (PCTG) which are present in a weight ratio of 15:85 to 85:15 is effective for improvement in luminance. When polycarbonate is present in an amount less than 15%, polymer viscosity required for spinning performance is excessively increased and use of a spinning machine is disadvantageously impossible, and when the polycarbonate is present in an amount exceeding 85%, a glass transition temperature increases and spinning tension increases, after discharge from a nozzle, thus making it difficult to secure spinning performance.

Meanwhile, methods for modifying isotropic materials into birefringent materials are well-known in the art and for example, polymeric molecules are oriented and materials thus become birefringent when they are drawn under suitable temperature conditions.

Materials for the sheet 30 that can be used in the present invention include thermoplastic and thermosetting polymers which can transmit a desired range of optical wavelengths and may be a transparent material enabling easy transmission of light. Preferably, the sheet 30 may be amorphous or semicrystalline and may include a monopolymer, a copolymer or a blend thereof. More specifically, examples of suitable sheets include poly(carbonate) (PC); syndiotactic and isotacticpoly(styrene) (PS); alkyl styrene; alkyl such as poly(methyl methacrylate) (PMMA) and PMMA copolymers, aromatic and aliphatic pendant (meth)acrylate; ethoxide and propoxide (meth)acrylate; multi-functional (meth)acrylate; acrylated epoxy; epoxy; and other ethylene unsaturated compounds; cyclic olefin and cyclic olefin copolymers; acrylonitrile butadiene styrene (ABS); styrene acrylonitrile (SAN) copolymers; epoxy; poly(vinyl cyclohexane); PMMA/poly(vinyl fluoride) blends; poly(phenylene oxide) alloys; styrene block copolymers; polyimide; polysulfone; poly(vinyl chloride); poly(dimethylsiloxane) (PDMS); polyurethane; unsaturated polyester; polyethylene; poly(propylene) (PP); poly(alkane terephthalate) such as poly(ethylene terephthalate) (PET); poly(alkane naphthalate) such as poly(etylene naphthalate) (PEN); polyamide; ionomers; vinyl acetate/polyethylene copolymers; cellulose acetate; cellulose acetate butyrate; fluoro polymers; poly(styrene)-poly(ethylene) copolymers; PET and PEN copolymers such as polyolefin PET and PEN; and poly(carbonate)/aliphatic PET blends. More preferably, examples of suitable sheets include polyethylene naphthalate (PEN), copolyethylene naphthalate (co-PEN), polyethylene terephthalate (PET), polycarbonate (PC), polycarbonate (PC) alloys, polystyrene (PS), heat-resistant polystyrene (PS), polymethyl methacrylate (PMMA), polybutylene terephthalate (PBT), polypropylene (PP), polyethylene (PE), acrylonitrile butadiene styrene (ABS), polyurethane (PU), polyimide (PI), polyvinyl chloride (PVC), styrene acrylonitrile (SAN) mixtures, ethylene vinyl acetate (EVA), polyamide (PA), polyacetal (POM), phenol, epoxy (EP), urea (UF), melanin (MF), non-saturated polyester (UP), silicon (Si), elastomers, cycloolefin polymers (COP, ZEON Co., Ltd. (Japan), JSR Co., Ltd. (Japan)) and combinations thereof. Furthermore, the sheet 30 may also contain an additive, such as an antioxidant, a light stabilizer, a heat stabilizer, a lubricant, a dispersing agent, a UV absorber, white pigment, and a fluorescent whitening agent, so long as the additive does not damage physical properties as mentioned above.

In particular, in view of operation efficiency, it is preferred that the sheet is an isotropic material which is the same as the sea or island portions.

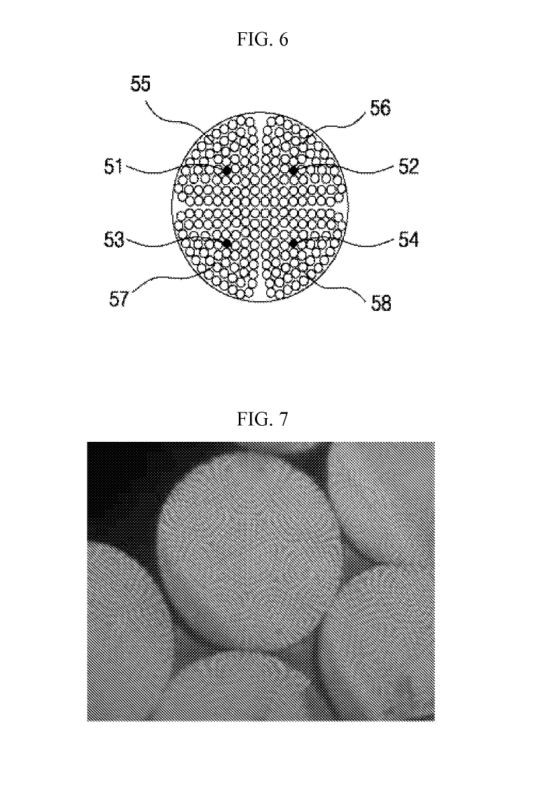

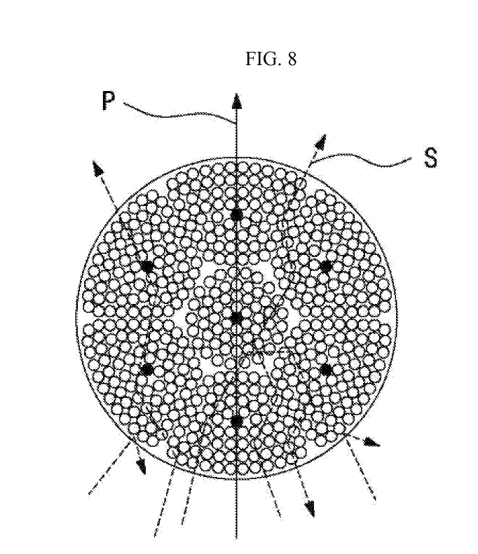

As mentioned above, the present invention may use specific island-in-the-sea yarns wherein the number of island portions is 38 to 1,500, as well as conventional island-in-the-sea yarns. FIG. 5 shows an island-in-the-sea yarn according to the present invention. As shown in FIG. 5, two spinning cores 41 and 42 are formed in an island-in-the-sea yarn 40 and island portions 43 and 44 are arranged such that they are grouped based on the spinning cores 41 and 42. That is, island portions 43 and 44 are arranged such that they are partitioned based on the respective spinning cores 41 and 42. As a result, as can be seen from the cross-section of the island-in-the-sea yarns 40, the number of groups of partitioned island portions is equivalent to the number of spinning cores. In this case, respective groups of the island portions 43 and 44 arranged based on the spinning cores 41 and 42 may have a cross-section such as a semicircle, a sector, a circle, a spheroid, a polygon or variant thereof, and their shapes are not particularly restricted and may be identical or different. For example, FIG. 6 is a sectional view illustrating a case wherein four spinning cores 51, 52, 53 and 54 are present in an island-in-the-sea yarn 50. The arrangement shape of island portions 55, 56, 57, 58 is a sector, as shown in FIG. 6, but a part thereof may be in the form of a triangle, a tetragon or a circle. Meanwhile, in the drawings, each spinning core is represented by a thick black dot, which is shown for clearer description purpose only, and means one point acting as an actual center of the groups and the point may be either an island portion or sea portion. Furthermore, spaces present in the island-in-the-sea yarn may be filled with island portions or the island-in-the-sea yarn may be composed of only sea portions. Meanwhile, FIG. 7 is an SEM image of the cross-section of the birefringent island-in-the-sea yarn (comprising 1016 islands) according to the present invention.

More specifically, in the island-in-the-sea yarn comprising optically isotropic sea portions and anisotropic island portions, the levels of substantial equality and inequality between refractive indexes along spatial axes X, Y and Z affect scattering of polarized light. Generally, scattering performance varies in proportion to the square of the difference in refractive index. Accordingly, as the difference in refractive index according to a specific axis increases, light polarized according to the axis is more strongly scattered. On the other hand, when the difference in refractive index according to a specific axis is low, a ray of light polarized according to the axis is weakly scattered. When the refractive index of sea portions at a specific axis is substantially equivalent to the refractive index of island portions, incident light that is polarized by an electric field parallel to this axis is not scattered, irrespective of the size, shape and density of a portion of the island-in-the-sea yarns, but may pass through the island-in-the-sea yarns. More specifically, FIG. 7 is a sectional view illustrating a passage in which light permeates birefringent island-in-the-sea yarns of the present invention. In this case, p waves (represented by lines) transmit island-in-the-sea yarns, independent from the interface between the outside and the birefringent island-in-the-sea yarns and the interface between island portions and sea portions present in birefringent island-in-the-sea yarns, while S waves (represented by dots) are affected by the interface between the sheet and the birefringent island-in-the-sea yarns and/or the interface between island portions and sea portions in the birefringent island-in-the-sea yarns and are thus optically modulated.

The afore-mentioned optical modulation phenomenon often occurs on the interface between the sheet and the birefringent island-in-the-sea yarns and/or the interface between island portions and sea portions in the birefringent island-in-the-sea yarns. More specifically, optical modulation occurs on the interface between the sheet and the birefringent island-in-the-sea yarn, like common birefringent fibers, when the sheet is optically isotropic. Specifically, the difference in refractive index between the sheet and the island-in-the-sea yarn with respect to two axial directions may be 0.05 or less and the difference in refractive index between the sheet and the island-in-the-sea yarn with respect to the remaining axial direction may be 0.1 or more. Assuming that x-, y- and z-axis refractive indexes of the sheet are nX1, nY1 and nZ1, respectively, and the x-, y- and z-axis refractive indexes of the island-in-the-sea yarn are nX2, nY2 and nZ2, respectively, at least one of x-, y- and z-axis refractive indexes of the sheet may be equivalent to that of the birefringent island-in-the-sea yarn and the refractive indexes of island-in-the-sea yarns may be nX2>nY2=nZ2.

Meanwhile, of the birefringent island-in-the-sea yarns, the island portions and the sea portions preferably have different optical properties in view of formation of the birefringent surface. More specifically, when the island portions are anisotropic and the sea portions are isotropic, birefringent surfaces may be formed on the interface therebetween, and more specifically, it is preferred that the difference in refractive index in two axes be 0.05 or less and the difference in refractive index in the remaining axis be 0.1 or more. In this case, P waves pass through birefringent interfaces of island-in-the-sea yarns, while S waves cause optical modulation. More specifically, assuming that x- (longitudinal), y- and z-axis refractive indexes of the island portion are nX3, nY3 and nZ3, respectively, and the x-, y- and z-axis refractive indexes of the sea portion are nX4, nY4 and nZ4, respectively, it is preferred that at least one of x-, y- and z-axis refractive indexes of the island portion be equivalent to that of the sea portion and an absolute value of the difference in refractive index between nX3 and nX4 be 0.05 or more. Most preferably, when the difference in refractive index between the sea portion and the island portion in island-in-the-sea yarns in a longitudinal direction is 0.1 or more and with respect to the remaining two axis directions, the refractive index of the sea portion is substantially equivalent to that of the island portion, optical modulation efficiency can be maximized.

Meanwhile, the birefringent island-in-the-sea yarns are arranged in the form of yarns or a fabric in the sheet. First, in the case where birefringent island-in-the-sea yarns are arranged in the form of yarns in the sheet, a plurality of birefringent island-in-the-sea yarns may preferably extend in one direction, and more preferably, the island-in-the-sea yarns may be arranged in the sheet vertically to a light source. In this case, optical modulation efficiency is maximized. Meanwhile, the island-in-the-sea yarns arranged in a row may be dispersed from one another, if appropriate, and the birefringent island-in-the-sea yarns may come in contact with one another or may be separated from one another. In the case where the island-in-the-sea yarns contact one another, they are close together to form a layer. For example, when three or more types of island-in-the-sea yarns, whose cross-sections have different diameters and are circular, are arranged, a triangle, which is obtained by interconnecting the centers of three circles adjacent to one another in the cross-sections perpendicular to their long axial directions, becomes a scalene. In addition, in the cross-sections taken perpendicular to the long axial directions of the island-in-the-sea yarns (cylindrical bodies), the cylindrical bodies are arranged such that the circle in a first layer contacts the circle in a second layer, the circle in the second layer contacts the circle in a third layer and the following layer contacts the next layer adjacent thereto. However, the condition that respective island-in-the-sea yarns contact two or more other island-in-the-sea yarns, which contact one another on the sides of their cylinders, on the side of the cylinder has only to be satisfied. Under this condition, a structure, in which the circle in the first layer contacts the circle in the second layer, the circle in the second layer and the circle in the third layer are spaced apart from each other through a support medium interposed therebetween, and the circle in the third layer contacts the circle in a fourth layer, may be designed.

It is preferred that the lengths of at least two sides of a triangle, which connects the centers of three circles directly contacting each other in the cross-sections perpendicular to the long axial direction of the island-in-the-sea yarn, be approximately identical. In particular, it is preferred that the lengths of three sides of the triangle be approximately identical. Further, in relation to a stack state of island-in-the-sea yarns in a thickness direction of the luminance-enhanced film, it is preferred that a plurality of layers be stacked such that two adjacent layers sequentially contact each other. Furthermore, it is more preferred that island-in-the-sea yarns in the form of cylinders having a substantially identical diameter be densely filled.

Accordingly, in such a more-preferred embodiment, the island-in-the-sea yarns have a cylindrical shape in which the diameters of circular cross-sections perpendicular to their long axial direction are substantially identical, and island-in-the-sea yarns located more inwardly than the outermost surface layer in the cross-section contact six other cylindrical island-in-the-sea yarns on the side of the cylinder.

It is preferable that the birefringent island-in-the-sea yarns have a volume of 1% to 90% with respect to the optical modulator of 1 cm³. When the volume is 1% or less, a luminance-reinforcement effect is slight. When the volume exceeds 90%, the amount of scattering increases due to the birefringent interface, disadvantageously causing optical loss.

Furthermore, the number of birefringent island-in-the-sea yarns arranged in the optical modulator of 1 cm³ may be 500 to 4,000,000. When the number is less than 500, luminance is hardly improved, and production efficiency may be deteriorated due to difficult production. Meanwhile, the sea portions and the island portions are present in an area ratio of 2:8 to 8:2, based on the cross-section of the birefringent island-in-the-sea yarn. When the area ratio is out of the range as defined, the birefringent interface area is reduced and enhancement in luminance may be deteriorated.

The luminance-enhanced film of the present invention may have a surface layer structured thereon, and more specifically, the structured surface layer may be formed on the side from which light is emitted. The structured surface layer may be in the form of a prism, lenticular or convex lens. More specifically, the side on the luminance-enhanced film from which light is emitted may have a curved surface in the form of a convex lens. The curved surface may focus or defocus light permeated into the curved surface. Also, the light-emitting surface may have a prism pattern.

Next, a method for preparing birefringent island-in-the-sea yarns according to the present invention will be described. The birefringent island-in-the-sea yarns may be applied to any general method for preparing island-in-the-sea yarns without particular limitation. Any spinneret or spinning nozzle may be used without restriction of shape so long as it enables preparation of birefringent island-in-the-sea yarns. Spinnerets or spinning nozzles having the substantially identical shape to the arrangement pattern of island portions on the cross-sections of birefringent island-in-the-sea yarns may be generally used. More specifically, any spinneret may be used so long as it can form island-in-the-sea yarns by combining island ingredients extruded from hollow pins or spinning nozzles suitably designed to partition island portions therein with a sea ingredient stream supplied from channels designed to fill the spaces provided therebetween, and extruding the combined stream from a discharge hole, while gradually thinning the stream, and island-in-the-sea yarns have two or more spinning centers.

The birefringent island-in-the-sea yarns may be arranged in the form of a fabric in the sheet. In this case, provided is a fabric comprising the birefringent island-in-the-sea yarns of the present invention as wefts and/or warps, and more preferably, provided is a fabric wherein the birefringent island-in-the-sea yarns are used as one of wefts and warps, and isotropic fibers are used as the other. The weft or warp may be composed of 1 to 200 threads of the island-in-the-sea yarns. More specifically, a melting initiation temperature of the island portions may be higher than the melting temperature of the isotropic fibers. When the lamination of the fabric woven using these materials to a sheet interposed therebetween through applying a predetermined heat and pressure to the sheet is carried out at a temperature higher than the melting temperature of the fibers and lower than the melting initiation temperature of the island portions, the island portions dose not reach the melting initiation temperature and are thus not melted, but the fibers are partially or entirely melted, since the lamination is carried out at a the temperature higher than the melting temperature of the fibers. As a result, the fibers used as wefts or warps are melted in the lamination process and thus constitute the sheet, thus obtaining the final luminance-enhanced film in which only birefringent island-in-the-sea yarns are present. For this reason, the phenomenon, appearance of the fibers, which commonly occurs on the luminance-enhanced film comprising fibers, can be solved. The melting initiation temperature of the island portions may be preferably 30° C. higher than (more preferably, 50° C. higher than) the melting temperature of the isotropic fibers. Any fibers may be used without particular limitation, so long as they are woven with the birefringent island-in-the-sea yarns to form a fabric and meet the afore-mentioned temperature conditions. Preferably, the fibers may be optically isotropic, when taking into consideration the fact that they are perpendicularly woven with the birefringent island-in-the-sea yarns. This is because when the fibers are also birefringent, light modulated through birefringent island-in-the-sea yarns may pass through the fibers. Examples of fibers that can be used include polymer, natural and inorganic fibers (such as glass fibers), and combinations thereof. More preferably, the fibers may be the same material as the sea-portions. Preferably, the fibers may be woven by a satin method. In addition, the weft or warp may be composed of 1 to 200 threads of the island-in-the-sea yarns.

Furthermore, in the case where a composite fiber is prepared by twisting several to several tens of island-in-the-sea yarns, for example, a composite fiber is prepared by twisting 10 island-in-the-sea yarns, the composite fiber has 100 birefringent interfaces and thus causes at least 100 times of optical modulation. Furthermore, in the case where island-in-the-sea yarns composed of several threads are prepared, for example, island-in-the-sea yarns composed of 10 threads, the composite fiber prepared from the yarns has 100 birefringent interfaces and thus causes at least 100 times of optical modulation. The island-in-the-sea yarns of the present invention may be prepared by a method such as co-extrusion, although not limited thereto.

After the intermediate layer is produced using the birefringent island-in-the-sea yarns, a sheet is laminated on one or both sides of the intermediate layer, and the laminate is hot-pressed using a vacuum hot press. Preferably, the hot-pressing is carried out at a vacuum level of 5 to 100 torr, at a pressure of 1.0 to 100 kgf/cm², at a temperature of 80 to 160° for a process period of 1 to 30 minutes.

When the vacuum level is less than 5 torr, process efficiency may be deteriorated, and when the vacuum level exceeds 500 torr, the removal of bubbles may be insufficient. In addition, when the application pressure is less than 1.0 kgf/cm², adhesion force of the film may be insufficient, and when the application pressure exceeds 100 kgf/cm², the structure of fabric is broken and the arrangement of fibers may thus be deformed due to excessive pressure. In addition, when the heating temperature is less than 120°, adhesion force of the film may be insufficient, and when the heating temperature exceeds 180°, the sheet or birefringent island-in-the-sea yarns may be crystallized or melted. In addition, when the process period is less than 1 minute, removal of bubbles and adhesion force may be insufficient, when the process period exceeds 30 minutes, process efficiency is undesirably low.

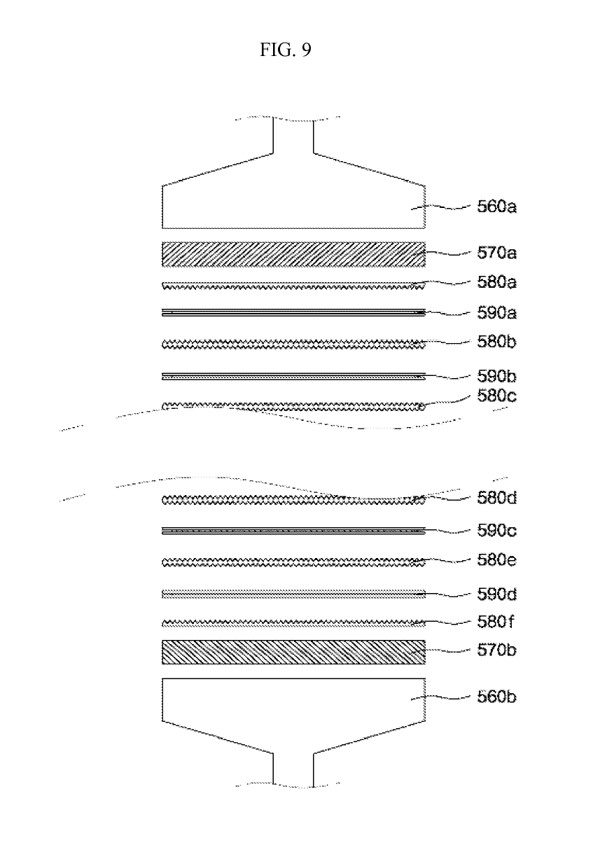

FIG. 9 is a schematic view illustrating the vacuum hot press used in the present invention. Referring to FIG. 9, a hot-pressing process using the vacuum hot press is carried out by interposing a plurality of laminated sheets 580a, 580b, 580c, 580d, 580e and 580f between heating plates 560a and 560b. Metal pads 590a, 590b, 590c and 590d are stacked between the respective laminated sheets, the sides which directly contact the heating plates arranged on the uppermost and lowermost parts of the laminated sheets are provided with cushion pads 570a and 570b, in order to apply a uniform pressure to the laminated sheets. By hot-pressing the laminated sheets as mentioned above, process efficiency can be improved. The metal pads are used to separate respective laminated sheets from each other and uniformize the heating temperature. The material for metal pads is particularly not limited and for example may be a SUS plate. Meanwhile, any material for the cushion pad may be used without particular limitation so long as it can provide cushion, and for example may be an elastic pad such as rubber.

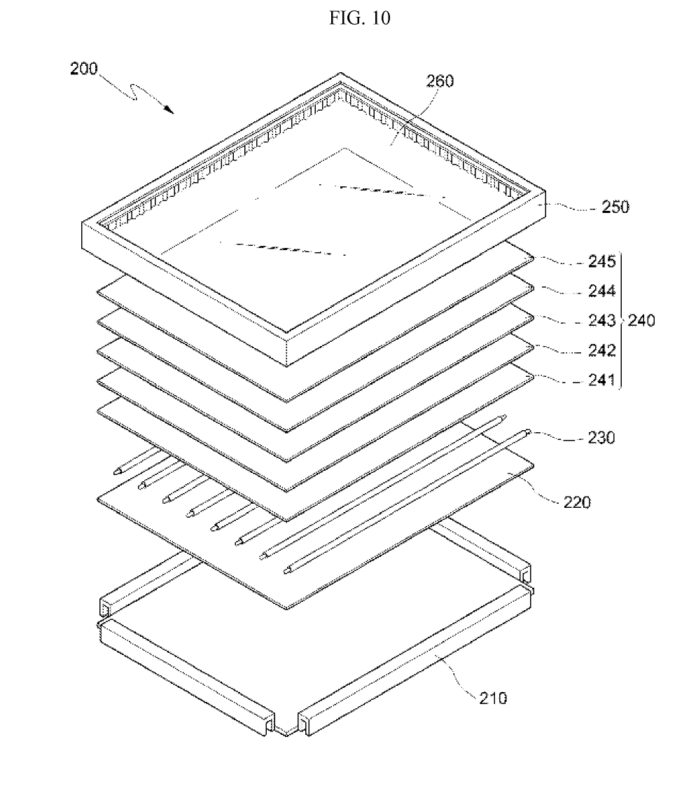

FIG. 10 shows an LCD device using the luminance-enhanced film according to one embodiment. In FIG. 10, a reflection plate 220, a plurality of cold cathode fluorescent lamps 230 and an optical film 240 are arranged on a frame 210 in this order from the bottom. The optical film 240 includes a diffusion plate 241, a light-diffusing film 242, a prism film 243, a luminance-enhanced film 244 and a polarized light-absorbing film 245 stacked in this order from the bottom. The stack order may be varied depending on intended purposes, or the elements may be omitted or provided in plural number. For example, the diffusion plate 241, the light-diffusing film 242 and the prism film 243 may be omitted, and the stack order or position thereof may be varied. Furthermore, other elements such as a phase-contrast film (not shown) may be inserted into the LCD device in a suitable position. Meanwhile, a liquid crystal display panel 260 placed in a mold frame 250 may be arranged on the optical film 240. In addition, LEDs may used as a light source, instead of the cold cathode fluorescent lamps 230.

The principle of the LCD device will be illustrated according to the passage of light. Light is irradiated from a backlight 230 and then transferred to the diffusion plate 241 of the optical film 240. Then, the light passes through the light-diffusing film 242 so that it can be directed vertical to the optical film 240. Then, the light passes through the prism film 243, arrives on the luminance-enhanced film 244 and at this time, undergoes optical modulation. Specifically, P-waves pass through the luminance-enhanced film 244 without optical loss. On the other hand, S waves undergo optical modulation (e.g., reflection, scattering, refraction), are reflected on the reflection plate 220 arranged on the rear surface of the cold cathode fluorescent lamp 230, are randomly converted into P- or S waves, and pass through the luminance-enhanced film 244 again. Then, the waves pass through the polarized light-absorbing film 245 and arrive on the liquid crystal display panel 260. As a result, it is expected that the LCD device into which the luminance-enhanced film of the present invention is introduced based on the afore-mentioned principle can considerably enhance luminance, as compared to the case of conventional luminance-enhanced films.

Meanwhile, the use of the luminance-enhanced film is described for LCDs, but is not limited thereto. That is, the luminance-enhanced film may be widely used in other apparatuses utilizing polarizing films

Hereinafter, the following Examples and Experimental Examples will be provided for a further understanding of the invention. These examples are for illustrative purposes only and are not intended to limit the scope of the present invention.

### Example 1

An isotropic PC alloy consisting of polycarbonate and modified glycol poly cyclohexylene dimethylene terephthalate (PCTG) in a ratio of 5:5 was used as a sea ingredient (nx=1.57, ny=1.57, nz=1.57) and anisotropic PEN (nx=1.88, ny=1.57, nz=1.57) was used as an island ingredient. In order to obtain island-in-the-sea yarns having the cross-section shown in FIG. 5, these materials were placed on a spinneret having the same cross-section as the island-in-the-sea yarns. Under this composition, undrawn yarns 150/24 were spun at a spinning temperature of 305° C. and at a spinning rate of 1,500 M/min and then drawn 3-fold to obtain 50/24 drawn yarns. An island-in-the-sea yarn fabric was woven using 24 threads of the island-in-the-sea yarns thus prepared as wefts. Then, an isotropic PC alloy sheet with a refractive index of 1.57 (with the same composition as the PC ally used for the sea portions) was laminated on both sides of the island-in-the-sea yarn fabric and was hot-pressed under vacuum of 15 torr using a vacuum hot press (MEIKI, Co. Ltd.) at a temperature of 160° C. at a pressure of 35 kgf/cm² for 25 minutes to fabricate a luminance-enhanced film with a thickness of 400 μm.

### Example 2

A luminance-enhanced film was fabricated in the same manner as in Example 1 except that the island-in-the-sea yarns, whose cross-section corresponds to that of FIG. 7, and wherein 130 island portions are arranged in one spinning core and the total number of island portions is thus 1040, were used.

### Comparative Example 1

A luminance-enhanced film with a thickness of 400 μm was fabricated in the same manner as in Example 1 except that the lamination was carried out in a general hot press, instead of the vacuum hot press.

### Comparative Example 2

A luminance-enhanced film with a thickness of 400 μm was fabricated in the same manner as in Example 2 except that the lamination was carried out in a general hot press, instead of the vacuum hot press.

### Experimental Example 1

The following physical properties of the luminance-enhanced films fabricated in Example 1 to 2 and Comparative Example 1 to 2 were evaluated and the results thus obtained are shown in Table 1 below.

### 1. Luminance

The following tests were performed, in order to measure the luminance of the luminance-enhanced films thus fabricated. A panel was assembled on a 32″ direct lighting type backlight unit provided with a diffusion plate, two diffusion sheets, and the luminance-enhanced film, and luminance at 9 points was measured using a BM-7 tester (TOPCON, Corp. Korea), and an average luminance value was obtained and shown.

### 2. Transmittance

Transmittance was measured in accordance with ASTM D1003 using a COH300A analyzer (NIPPON DENSHOKU Co., Ltd. Japan).

### 3. Degree of Polarization

The degree of polarization was measured using an RETS-100 analyzer (OTSKA Co., Ltd., Japan).

### 4. Luminance Uniformity

A panel was assembled on a 32″ direct lighting type backlight unit provided with a diffusion plate, two diffusion sheets, and the luminance-enhanced film. Luminance uniformity (the presence of defects) was observed with the naked eye and the results thus obtained were marked by ∘, Δ or x.

### ∘: Good, Δ: Normal, x: Bad

### 5. Curling

The luminance-enhanced film was assembled in a 32-inch backlight unit, stood in a thermo-hygrostat at RH 75%, 60° C. for 96 hours and then disassembled. A curling level of the luminance-enhanced film was observed with the naked eye and the results thus obtained were marked by ∘, Δ or x.

### ∘: Good, Δ: Normal, x: Bad

### 6. UV-Resistance

The luminance-enhanced film was irradiated using a 130-mW ultraviolet lamp (365 nm) at a height of 10 cm using SMDT51H (SEI MYUNG VACTRON CO., LTD. Korea) for 10 minutes. Yellow index (YI) before and after treatment was measured using an SD-5000 analyzer (NIPPON DENSHOKU Co., Japan) and a yellowing level was thus evaluated.

TABLE 1

| | | | Degree of | | | |
|---|---|---|---|---|---|---|
| | Luminance | Transmittance | polarization | Luminance | | |
| | (cd/m²) | (%) | (%) | uniformity | Curling | UV-resistance |
| Ex. 1 | 400 | 52 | 78 | ◯ | ◯ | 1.9 |
| Ex. 2 | 420 | 48 | 80 | ◯ | ◯ | 1.8 |
| Comp. Ex. 1 | 400 | 52 | 78 | Δ | Δ | 1.8 |
| Comp. Ex. 2 | 420 | 48 | 80 | Δ | Δ | 1.8 |

As can be seen from Table 1, the luminance-enhanced films according to the present invention exhibited superior luminance uniformity and did not undergo curling, as compared to the conventional luminance-enhanced films (Comparative Examples 1 to 2).

### Experimental Example 2

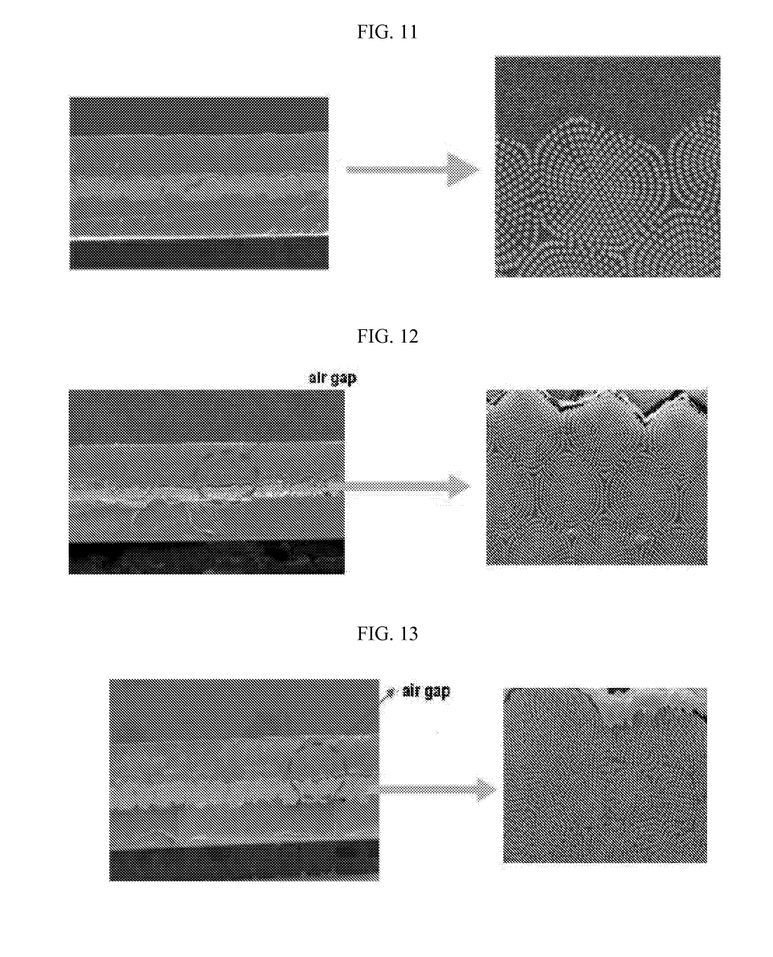

The SEM images of the cross-sections of the luminance-enhanced films fabricated in Example 1, Comparative Examples 1 and 2 were obtained and the results thus obtained are shown in FIGS. 11 to 13. In FIG. 11 (Example 1), no air gaps were observed, and the sheet and the intermediate layer closely contacted each other without forming any air gaps therebetween. On the other hand, in FIGS. 12 and 13 (Comparative Examples), air gaps remain, causing deterioration in adhesion force and luminance uniformity.

The luminance-enhanced film of the present invention exhibits superior optical modulation performance and may thus be widely utilized in high luminance-requiring LCD devices and LEDs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A luminance-enhanced film comprising:
an intermediate layer having a first side and a second side, the intermediate layer comprising a birefringent island-in-the-sea yarn; and
a sheet laminated on both sides of the intermediate layer,
wherein an interface between the intermediate layer and the sheet has an air-gap area ratio of 3% or less.

2. The luminance-enhanced film according to claim 1, wherein a surface defect number is 3 per m² or less.

3. The luminance-enhanced film according to claim 1, wherein a stack strength between the intermediate layer and the sheet is 500 g/15 mm width or higher.

4. The luminance-enhanced film according to claim 1, wherein the birefringent island-in-the-sea yarn has a birefringent interface on the boundary between the island portions and sea portions.

5. The luminance-enhanced film according to claim 4, wherein the island portions are anisotropic and the sea portions are isotropic.

6. The luminance-enhanced film according to claim 3, wherein the island portions and the sea portions are each independently composed of a material selected from the group consisting of polyethylene naphthalate (PEN), copolyethylene naphthalate (co-PEN), polyethylene terephthalate (PET), polycarbonate (PC), polycarbonate (PC) alloys, polystyrene (PS), heat-resistant polystyrene (PS), polymethyl methacrylate (PMMA), polybutylene terephthalate (PBT), polypropylene (PP), polyethylene (PE), acrylonitrile butadiene styrene (ABS), polyurethane (PU), polyimide (PI), polyvinyl chloride (PVC), styrene acrylonitrile (SAN) mixtures, ethylene vinyl acetate (EVA), polyamide (PA), polyacetal (POM), phenol, epoxy (EP), urea (UF), melanin (MF), non-saturated polyester (UP), silicon (Si), elastomers, cycloolefin polymers and combinations thereof.

7. The luminance-enhanced film according to claim 1, wherein the sheet is isotropic.

8. The luminance-enhanced film according to claim 1, wherein the sheet is the same material as at least one of the island portions and the sea portions.

9. The luminance-enhanced film according to claim 1, wherein a difference in refractive index between the sheet and the island-in-the-sea yarn with respect to two axial directions is 0.05 or less and a difference in refractive index between the sheet and the island-in-the-sea yarn with respect to the remaining one axial direction is 0.1 or more.

10. The luminance-enhanced film according to claim 1, wherein assuming that x-, y- and z-axis refractive indexes of the sheet are nX1, nY1 and nZ1, respectively, and the x-, y- and z-axis refractive indexes of the island-in-the-sea yarn are nX2, nY2 and nZ2, respectively, at least one of x-, y- and z-axis refractive indexes of the sheet is equivalent to that of the birefringent island-in-the-sea yarn.

11. The luminance-enhanced film according to claim 10, wherein the refractive indexes of the birefringent island-in-the-sea yarn are nX2>nY2=nZ2.

12. The luminance-enhanced film according to claim 1, wherein a difference in refractive index between the sea portion and the island portion with respect to two axial directions is 0.05 or less and a difference in refractive index between the sea portion and the island portion with respect to the remaining one axial direction is 0.1 or more.

13. The luminance-enhanced film according to claim 12, wherein assuming that x- (longitudinal), y- and z-axis refractive indexes of the island portion are nX3, nY3 and nZ3, respectively, and the x-, y- and z-axis refractive indexes of the sea portion are nX4, nY4 and nZ4, respectively, at least one of x-, y- and z-axis refractive indexes of the island portion is equivalent to that of the sea portion.

14. The luminance-enhanced film according to claim 1, wherein the refractive index of the sea portion in the island-in-the-sea yarns is equivalent to the refractive index of the sheet.

15. The luminance-enhanced film according to claim 1, wherein the intermediate layer comprises a fabric woven using the birefringent island-in-the-sea yarn as at least one of weft and warp.

16. The luminance-enhanced film according to claim 1, wherein one of weft and warp of the fabric is birefringent island-in-the-sea yarn and the other is an isotropic fiber,
wherein the birefringent island-in-the-sea yarn has a melting initiation temperature higher than a melting temperature of the isotropic fiber.

17. The luminance-enhanced film according to claim 1, wherein the birefringent island-in-the-sea yarn comprises island portions grouped based on two or more spinning cores, and the total number of the island portions is 38 to 1,500.

18. The luminance-enhanced film according to claim 1, wherein the air-gap area ratio is 1.5% or less.

19. A method for fabricating a luminance-enhanced film comprising:
preparing an intermediate layer comprising a birefringent island-in-the-sea yarn, the intermediate layer having a first side and a second side;
laminating a sheet on both sides of the intermediate layer to prepare a laminated sheet; and
hot-pressing the laminated sheet using a vacuum hot press.

20. The method according to claim 19, wherein the hot-pressing is carried out under a vacuum level of 5 to 500 torr.

21. The method according to claim 19, wherein the hot-pressing is carried out at a pressure of 1.0 to 100 kgf/cm² and at a temperature of 120 to 180° C.

22. The method according to claim 19, wherein the hot-pressing is carried out for a process period of 1 to 30 minutes.

23. The method according to claim 19, wherein the hot-pressing is carried out by interposing a plurality of the laminated sheets between heating plates, wherein metal pads are laminated between the respective laminated sheets.

24. The method according to claim 19, wherein the luminance-enhanced film has an air-gap area ratio of 5% or less of the interface between the intermediate layer and the sheet.
